(19) United States
(12) Patent Application Publication
(10) Pub. No.: US 2010/0096544 A1
(43) Pub. Date: Apr. 22, 2010

(54) Surface Sampling Probe for Field Portable Surface Sampling Mass Spectrometer

(75) Inventors: Laurence E. Slivon, Mount Vernon, OH (US); Donald V. Kenny, Powell, OH (US); Carl A. Alexander, Grove City, OH (US); Julius S. Ogden, Grove City, OH (US); Lee A. Siers, Hilliard, OH (US); Timothy L. Hayes, Westerville, OH (US); Lindy E. Dejarme, Columbus, OH (US)

Correspondence Address: DIEDERIKS & WHITELAW, PLC, 13885 HEDGEWOOD DR., SUITE 317, WOODBRIDGE, VA, 22193, US

(73) Assignee: BATTELLE MEMORIAL INSTITUTE, Columbus, OH (US)

(21) Appl. No.: 12/579,782

(22) Filed: Oct. 15, 2009

Related U.S. Application Data
(60) Provisional application No. 61/106,030, filed on Oct. 16, 2008.

(51) Int. Cl. H01J 49/00; B01D 59/44

(52) U.S. Cl. 250/282; 250/288

(57) ABSTRACT

A portable detection device includes a surface sampling probe connected to a mass spectrometer, preferably mounted on a portable cart, and a transfer line for transporting samples from the probe to the mass spectrometer. The surface sampling probe is formed from a circular block or disk of metal such as copper and is provided with various holes in which cartridge heaters are located. The disk is preferably electroplated with nickel and then gold to allow for efficient heat transfer to the surface to be sampled. With this arrangement, in addition to other advantages, the presence of very low volatile or non-volatile materials may be determined.

### CROSS-REFERENCE TO RELATED APPLICATIONS

The present invention claims the benefit of U.S. Provisional Patent Application Ser. No. 61/106,030, filed Oct. 16, 2008, entitled “Surface Sampling Probe for Field Portable Surface Sampling Mass Spectrometer.”

### BACKGROUND OF THE INVENTION

1. Field of the Invention

The present invention pertains to the art of surface sampling probes and, more particularly, to the structure and use of a surface sampling probe connected to a small field portable mass spectrometer for the purpose of detecting the presence of very low or non-volatile materials from contaminated surfaces.

2. Discussion of the Prior Art

Often it is important to quickly and accurately determine the level and type of contamination present on a surface in both civil and military settings. Several types of contamination, such as illegal drugs, explosive compounds, and chemical and biological weapons must be detected and classified quickly. Some types of contamination have a fairly high volatility, for example various explosives such as nitroglycerin, trinitrotoluene (TNT) and ethylene glycol dinitrate (EGDN), all have a relatively high vapor pressure.

Various technologies have been proposed for surface contamination sampling. For example, mass spectrometry has long been used to accurately determine the presence of initially unknown chemical and biological samples. Usually a sample is vaporized and ionized, with the resulting ions being measured to determine a mass to charge ratio spectrum which is, in turn, used to identify the basic constituents of the original sample. Due to the large size and power requirements of most mass spectrometers, they have typically been housed in a dedicated laboratory. As such, samples were collected at a potentially contaminated site and brought to the mass spectrometer for analysis. This tended to be a time consuming and expensive endeavor, especially if the surface being analyzed was on a ship or located a far distance from the laboratory. In the case of a potentially contaminated runway, having a team of technicians take samples and send the samples away for analysis is simply not a cost effective or practical way of addressing this problem.

In order to address the problem of analyzing samples at a contamination site, portable field detection systems have been developed. For example, U.S. Patent Application Publication No. 2005/0263694 discloses a portable system that incorporates a mass spectrometer designed to detect small levels of biological or chemical samples found in the field. U.S. Pat. No. 6,351,983 discloses a hand portable gas chromatograph mass spectrometer that permits rapid on-site chemical analysis of unknown chemicals. While each of these proposed arrangements describes a portable detection system using a mass spectrometer, neither of them addresses certain problems encountered when obtaining the sample, especially if the sample is a low or non-volatile substance.

One proposed method of obtaining a sample is set forth in U.S. Pat. No. 4,909,090 which proposes to essentially blow air over a surface and onto a collector. Optionally, a separate heater may be used to heat the surface while blowing the air. This device may be able to collect samples of various explosives, such as nitroglycerin, trinitrotoluene (TNT) and ethylene glycol dinitrate (EGDN), all of which have a relatively high vapor pressure. However, the device is not designed to detect contaminants of low vapor pressure.

Based on the above, there exists a need in the art for a portable device which is capable of accurately determining the presence of various contamination compounds, particularly very low volatile compounds which would traditionally be considered hard to collect and analyze, on a contaminated surface without having to either remove the surface or send samples of the potential contamination away for analysis at a central laboratory.

### SUMMARY OF THE INVENTION

The present invention is directed to a field portable detection device and method capable of accurately determining the presence of very low volatile or non-volatile materials. More specifically, the detection device includes a surface sampling probe connected to a mass spectrometer, and is preferably mounted on a mobile platform such as a portable cart that has wheels and a handle so that the device may be easily transported. The detection device also includes a transfer line for transporting the samples from the probe to the mass spectrometer. The surface sampling probe is formed from a circular block or disk of metal such as copper. The sampling disk is provided with various holes in which cartridge heaters are located and includes an outer periphery, a top surface and a central pathway. The sampling surface further includes radially extending grooves that extend from the outer periphery to the central pathway for allowing the sample to travel through the grooves and pathway to the transfer line. The disk is preferably electroplated with nickel and then gold to allow for efficient heat transfer to the surface to be sampled. The gold also provides a chemically inert surface that can come in contact with the surface. The center of the disk is drilled out for a fitting. A transfer line is connected to the fitting and allows for a gaseous sample to travel from the fitting to the mass spectrometer. Preferably, a heater tape heats the transfer line.

In use a sample is obtained from a surface to determine a presence of a low-volatile material on the surface. The field portable detection device is moved to a test surface. The surface is heated with the surface sampling probe using the cartridge heaters. A sample is obtained from the heated surface with the surface sampling probe by creating a vacuum in the transfer line and drawing the sample through the grooves located on the bottom of the sampling probe. The sample is then transferred between the surface sampling probe and the mass spectrometer through the heated transfer line. The mass spectrometer then determines if a low-volatile material is present in the sample.

With this arrangement, in addition to other advantages, even the presence of non-traditional agents formed from very low or non-volatile materials may be determined. Additional objects, features and advantages of the present invention will become more readily apparent from the following detailed description of a preferred embodiment when taken in conjunction with the drawings wherein like reference numerals refer to corresponding parts in the several views.

### BRIEF DESCRIPTION OF THE DRAWINGS

FIG. 1 is a perspective view of a field portable detection device including a heated surface sampling probe connected to a mass spectrometer by a heated transfer line according to a preferred embodiment of the invention;

FIG. 2 is a perspective view of the heated inlet probe showing holes for cartridge heaters and a fitting for interfacing with the transfer line;

FIG. 3 shows a bottom perspective view of the surface sampling probe of FIG. 1 depicting grooves that allow for airflow over a surface being analyzed; and

FIG. 4 shows the transfer line of FIG. 1 cut to show a cross-section.

### DETAILED DESCRIPTION OF THE PREFERRED EMBODIMENT

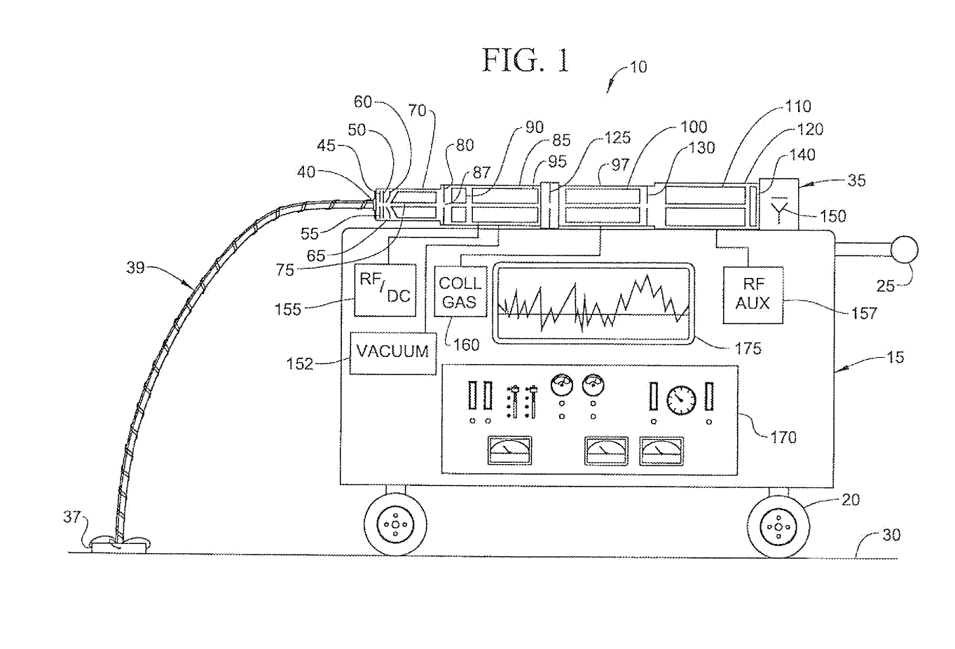

With initial reference to FIG. 1 there is shown a field portable detection device 10 capable of accurately determining the presence of very low volatile or non-volatile materials. As shown, detection device 10 is mounted on a mobile platform such as a portable cart 15 that has wheels 20 and a handle 25 so that device 10 may be easily moved around on a support surface 30, such as an airplane runway, which may be contaminated. Preferably, device 10 is both self-contained and portable. Detection device 10 includes a mass spectrometer 35 for analyzing samples obtained via a surface sampling probe 37, and a transfer line 39 for transporting the samples from probe 37 to mass spectrometer 35.

Mass spectrometer 35 is shown schematically as a triple quadrupole mass spectrometer apparatus. Transfer line 39 has a first end connected to surface sampling probe 37 and a second end attached to mass spectrometer 35 at an ion source 40, which generates ions directed towards a curtain plate 45. Ion source 40 is preferably an atmospheric pressure chemical ionization (APCI), but any suitable ion source may be used. Behind curtain plate 45 is an orifice plate 50 defining an orifice in known manner. A curtain chamber 55 is formed between curtain plate 45 and orifice plate 50, with a flow of curtain gas reducing the flow of unwanted particles into mass spectrometer 35.

Following orifice plate 50, there is a skimmer plate 60. An intermediate pressure chamber 65 is defined between orifice plate 50 and skimmer plate 60. Ions pass through skimmer plate 60 into a first chamber 70 of mass spectrometer 35. A quadrupole rod set 75 is provided in chamber 70, for collecting and focusing ions. A first lens 80 separates chamber 70 from a main mass spectrometer chamber 85 and has an aperture 87 for ions. Adjacent first lens 80, there is provided a short rod set 90, or Brubaker lens.

A first mass resolving quadrupole rod set 95 is provided in chamber 85 for mass selection of a precursor ion. Following first mass resolving rod set 95 is a collision cell or chamber 97 containing a second quadrupole rod set 100 and, following collision cell 97, there is provided a third quadrupole rod set 110 for effecting a second mass analysis step. The final or third quadrupole rod set 110 is located in a main quadrupole chamber 120. As indicated, second quadrupole rod set 100 is contained within an enclosure forming collision cell 97, so that it can be maintained at a higher pressure. Lenses 125 and 130 are provided at either end of the enclosure defined by collision cell 97 and form barriers between the quadrupole sets. Ions leaving third quadrupole rod set 110 pass through an exit lens 140 to a detector 150.

A vacuum source 152 is connected to chambers 55, 65, 70, 85, 97 and 120 to regulate the pressures therein. A power supply 155 is provided for supplying RF and DC resolving voltages to first mass resolving quadrupole rod set 95. Similarly, a second power supply 157 is provided for supplying drive RF and auxiliary AC voltages to third quadrupole rod set 110. As indicated at 160, a collision gas is supplied to collision cell 97 for maintaining a desired pressure therein, and an RF is connected to second quadrupole rod set 100 within collision cell 97. A control panel 170 controls mass spectrometer 35 and the results of any test analyses may be displayed on a display screen 175.

It will be understood by those skilled in the art that the representation of FIG. 1 is schematic, and various additional elements would be provided to complete the apparatus. For example, a variety of power supplies are required for delivering AC and DC voltages to different elements of the apparatus. In addition, a pumping arrangement or scheme is provided to maintain the pressures at the desired levels. However, since these general components and operation of a mass spectrometer as described above are well known in the art and the details thereof are not part of the present invention, they will not be further discussed herein. However, for the sake of completeness, details of a mass spectrometer which can be used with the invention can be found in U.S. Pat. No. 6,627,876 which is incorporated herein by reference. Actually, at this point, it should be realized that various mass spectrometer arrangements are known in the art and can be employed in connection with the present invention. For instance, U.S. Patent Application Publication No. 2005/0263694, also incorporated herein by reference, discloses a portable system employing a mass spectrometer designed to detect small levels of biological or chemical samples found in the field, while U.S. Pat. No. 6,351,983, also incorporated herein by reference, discloses a hand portable gas chromatograph mass spectrometer that permits rapid on-site chemical analysis of unknown chemicals.

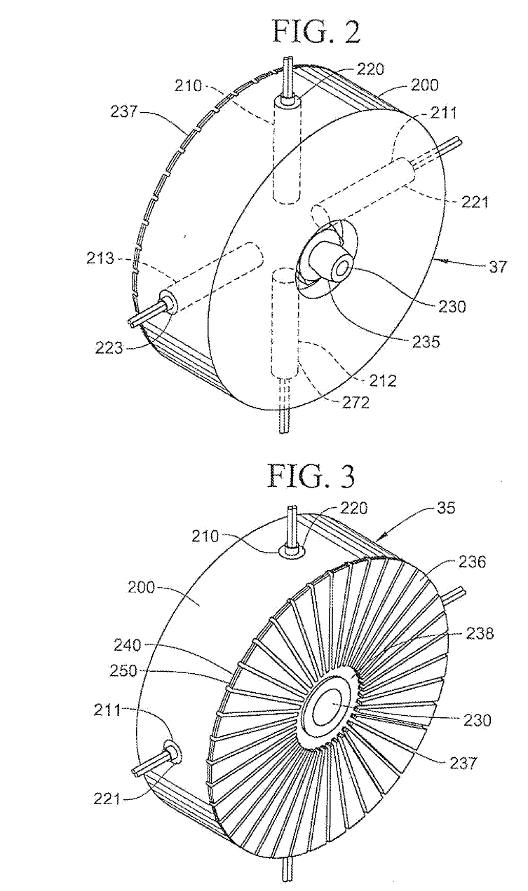

Surface sampling probe 37, as constructed in accordance with a preferred embodiment of the invention, can best be seen in FIGS. 2 and 3. Sampling probe 37 is fabricated to sample trace contamination of volatile, semi-volatile and non-volatile materials from various surfaces. Preferably, surface sampling probe 37 comprises a 3 inch (about 7.6 cm) diameter block of copper generally forming a main body that is preferably shaped as a disk 200. Disk 200 has four, approximately ¼ inch (about 0.6 cm) holes. 210, 211, 212 and 213 drilled therein. Each of holes 210, 211, 212 and 213 is sized to hold a respective one of cartridge heaters 220, 221, 222 and 223 that preferably are rated at 100 watts each. The center of disk 200 is drilled to provide for a pathway 230 that extends completely through disk 200. The top of disk 200 is provided with a fitting 235 which is adapted to be received within transfer line 39 to connect pathway 230 to transfer line 39 as depicted in FIG. 1. A bottom surface 236 of disk 200 is provided with a plurality of spaced, radially extending grooves 237 that extend from an outer circumference of disk 200 to a central; recessed receiving region 238 and allow for airflow across bottom surface 236 of disk 200 to pathway 230 and then to transfer line 39. As such bottom surface 236 may act as a sampling surface. In a preferred embodiment of the invention, grooves 237 are approximately ⅛ inch (0.3 cm) wide and establish there between a plurality of fins (not labeled) about bottom surface 236. A gaseous sample may be transferred from surface 30 being scanned to mass spectrometer 35 for analysis. Once disk 200 has been shaped and holes 210, 211, 212 and 213 for cartridge heaters 220, 221, 222 and 223 and pathway 230 have been drilled, disk 200 is then preferably electroplated with one or more layers to provide enhanced compatibility with potentially contaminated surface 30. In accordance with the most preferred embodiment of the invention, disk 200 is electroplated first with a nickel layer 240 and then with a gold layer 250. In addition to providing the desired compatibility, nickel layer 240 and gold layer 250 also do not significantly interfere with heat transferred from cartridge heaters 220, 221, 222 and 223 to potentially contaminated surface 30. Furthermore, nickel layer 240 and gold layer 250 advantageously provide a chemically inert surface. Although not shown, an additional cover gas may be provided as a blanket around disk 200 in order to prevent surface sampling probe 37 from collecting extraneous vapor from outside the probe's sampling region. Such a cover gas can also be beneficial when trying to accurately pinpoint the source of a spill on surface 30.

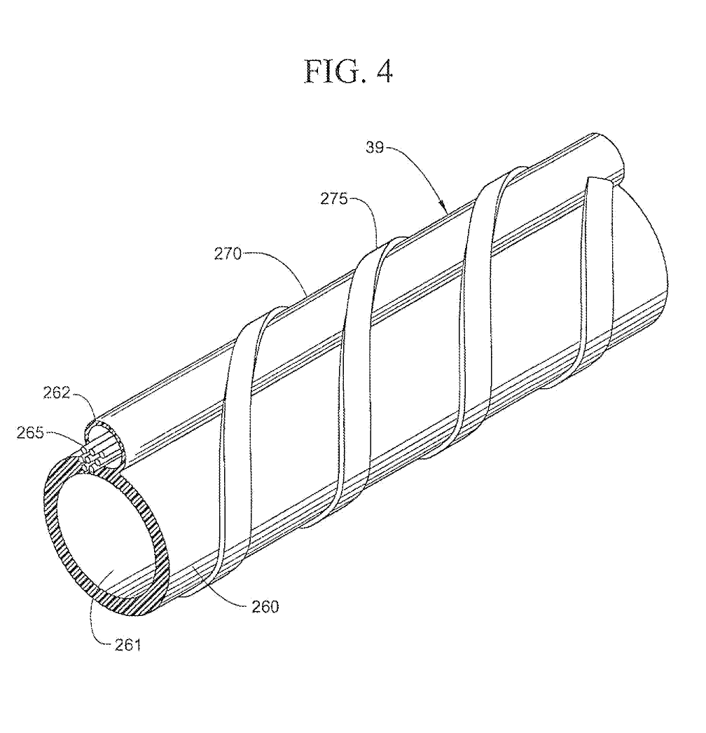

Turning now to FIG. 4, transfer line 39 is shown cut to show a cross-section. Transfer line 39 includes a main hollow base portion 260 having a longitudinal passageway 261 provided to transport collected samples. An auxiliary longitudinal passageway 262 is provided to carry wires 265 that supply power to cartridge heaters 220, 221, 222 and 223. Wrapped around an outside surface 270 of transfer line 39 is a heater tape 275 positioned to heat transfer line 39.

In operation, field portable detection device 10 is moved to a location having a potentially contaminated surface 30 to be tested. The cartridge heaters 220, 221, 222 and 223 are turned on to heat contaminated surface 30. Preferably, surface sampling probe 37 is heated to approximately 120° C. and held against a portion of surface 30 until that portion of surface 30 is heated. Air is then drawn over surface 30 to obtain samples. More specifically, a vacuum is created in transfer line 39 such that samples are drawn across bottom surface 236 of sampling probe 37, specifically along grooves 237 to central, recessed receiving region 238 and then to pathway 230. From pathway 230, the samples travel through disk 200 and into passageway 261 of transfer line 39, which is also heated, preferably to 140° C. The samples then travel to an inlet (not separately labeled) at ion source 40 of mass spectrometer 35 and undergo atmospheric pressure chemical ionization (APCI). Mass spectrometer 35 is then employed to determine what compounds are present in the samples from surface 30. Surface sampling probe 37 can then be moved to another location for another test. Alternatively, portable detector 10 may simply be set to continuously monitor a specific area.

Based on the above, it should be readily apparent that the present invention provides for a quite compact, field portable detection device that can be used to detect a wide range of contaminants on a surface. At the same time, the portable device will aid in cleaning up a contamination spill, such as on an airplane runway. In addition to being used in connection with contaminated samples, the field portable detection device constructed in accordance with the present invention can be readily employed to detect a wide range of non-volatile contaminants which cannot be detected by most conventional probes.

Although described with reference to a preferred embodiment of the invention, it should be readily understood that various changes and/or modifications can be made to the invention without departing from the spirit thereof. For instance, the actual dimensions of the probe, the number of heaters, the size of the transfer fittings, the width and depth of the grooves, and the shape and configuration of the fins on the bottom of the probe can be optimized for airflow based on the particular sampling environment. In addition, it should be realized that the fluid flow and electrical containment tubes of the transfer line could be formed separate or be concentrically arranged. Furthermore, although shown in the form of a cart, the field portable detection device of the invention could actually be made even smaller so as to enable it to be carried by hand.

1. A field portable detection device for analyzing a sample obtained from a surface to determine a presence of a low volatile or non-volatile material on the surface comprising:
a mobile platform;
a mass spectrometer mounted on the mobile platform for determining a contents of a sample;
a surface sampling probe including a main body defining a sampling surface and at least one heater supported by the main body; and
a heated transfer line including a first end portion connected to the surface sampling probe and a second end portion connected to the mass spectrometer, whereby a sample obtained by the surface sampling probe can be directed into the transfer line and travel to the mass spectrometer to determine if a low volatile or non-volatile material is present in the sample.

2. The detection device of claim 1, wherein the sampling surface is provided with a chemically inert layer.

3. The detection device of claim 2, wherein the chemically inert layer constitutes a gold layer.

4. The detection device of claim 1, further comprising: a nickel layer electroplated on the sampling surface of the main body.

5. The detection device of claim 4, wherein the sampling surface further includes a gold layer electroplated on the nickel layer.

6. The detection device of claim 1, wherein the main body is in the shape of a disk including an outer circumference, a top surface and a central pathway, and wherein the sampling surface defines a bottom surface of the main body, with the bottom surface being provided with radially extending grooves that extend from an outer periphery to the central pathway for allowing the sample to travel through the grooves and pathway to the transfer line.

7. The detection device of claim 1, wherein the main body is in the shape of a disk including at least one radially extending hole formed therein, the at least one heater being positioned in the at least one hole to uniformly heat the sampling surface.

8. The detection device of claim 1, wherein the transfer line further includes a passageway for carrying the sample and a heater tape for heating the passageway.

9. A surface sampling probe for obtaining a sample from a surface to determine a presence of a low volatile or non-volatile material on the surface comprising:
a main body defining a sampling surface; and
at least one heater supported by the main body, whereby a sample obtained by the surface sampling probe can be directed into a heated transfer line and travel to a mass spectrometer to determine if a low-volatile or non-volatile material is present in the sample.

10. The surface sampling probe of claim 9, wherein the sampling surface is provided with a chemically inert layer.

11. The surface sampling probe of claim 10, wherein the chemically inert layer constitutes a gold layer.

12. The surface sampling probe of claim 9, further comprising: a nickel layer is electroplated on the sampling surface of the main body.

13. The surface sampling probe of claim 12, wherein the sampling surface further includes a gold layer electroplated on the nickel layer.

14. The surface sampling probe of claim 9, wherein the main body is in the shape of a disk including an outer circumference, a top surface and a central pathway, and wherein the sampling surface defines a bottom surface of the main body, with the bottom surface being provided with radially extending grooves that extend from an outer periphery to the central pathway for allowing the sample to travel through the grooves and pathway to the transfer line.

15. The surface sampling probe of claim 9, wherein the main body is in the shape of a disk including at least one radially extending hole formed therein, the at least one heater being positioned in the at least one hole to uniformly heat the sampling surface.

16. A method for analyzing a sample obtained from a surface to determine a presence of a low volatile or non-volatile material on the surface comprising:
transporting a field portable detection device to a surface;
heating the surface with a surface sampling probe connected to a mass spectrometer of the field portable detection device;
obtaining a sample from the heated surface through the surface sampling probe;
transferring the sample through a transfer line connected between the surface sampling probe and the mass spectrometer; and
determining if a low volatile or non-volatile material is present in the sample with the mass spectrometer.

17. The method of claim 16, wherein heating the surface further includes activating cartridge heaters mounted in the surface sampling probe and placing the surface sampling probe against the surface.

18. The method of claim 16, wherein obtaining the sample from the heated surface further includes creating a vacuum in the transfer line and drawing the sample through grooves located on a bottom of the surface sampling probe.

19. The method of claim 18, wherein obtaining the sample from the heated surface further includes directing the sample across a chemically inert surface established on the bottom of the surface sampling probe.

20. The method of claim 16, wherein transferring the sample through the transfer line further includes heating the transfer line while transferring the sample.
